(19) United States
(12) Patent Application Publication
(10) Pub. No.: US 2015/0075925 A1
(43) Pub. Date: Mar. 19, 2015

(54) FLOATING BRAKE DISC ASSEMBLY

(71) Applicant: Kun-Liang Chieh, Changhua County (TW)

(72) Inventor: Kun-Liang Chieh, Changhua County (TW)

(21) Appl. No.: 14/027,244

(22) Filed: Sep. 16, 2013

(51) Int. Cl. F16D 65/12

(52) U.S. Cl. CPC F16D 65/121; F16D 2065/1312
USPC 188/218 XL

(57) ABSTRACT

A floating brake disc assembly includes a disc body and fasteners. The disc body includes a hub member and a brake rotor circumferentially around the hub member. The hub member and the brake rotor together defines connecting holes. Each fastener includes a rivet pin, a coned-disc spring and a protection washer next to the coned-disc spring. The coned-disc spring has a conical body and a positioning post axially extending from the conical body. The protection washer defines in an inner wall of its central bore a dent for reception of the respective positioning post of the coned-disc spring. The rivet pin passes through the connecting hole of the disc body, a central hole of the coned-disc spring and the central bore of the protection washer so as to fasten the hub member and the brake rotor together while allowing slight floating movement of the brake rotor relative to the hub member therebetween.

### BACKGROUND OF THE INVENTION

1. Field of the Invention

The present invention relates to a floating brake disc assembly and more particularly to a floating brake disc assembly in which a brake rotor is mounted to a hub member and a coned-disc spring is employed to enable the whole brake rotor to float relative to the hub member in parallel.

2. Description of the Related Art

Conventional floating brake disc assembly 9, as shown in FIG. 5, includes a hub member 92 and a brake rotor 93 connected together by means of a rivet pin 91 running through a connecting hole 90 defined in between the hub member 92 and the brake rotor 93 in a manner that the brake rotor 93 is allowed to move axially relative to the hub member 92 to a limited amount, whilst being constrained to rotate with the hub member 92. In particular, the floating brake disc assembly 9 further includes a coned-disc spring 94 and a washer 95 mounted around the rivet pin 91 such that the whole rotor 93 can float in parallel relative to the hub member 92.

However, during the manufacture of the floating brake disc assembly 9, the coned-disc spring 94 may not be well centered on the rivet pin 91 as desired, as shown in FIG. 6. Thus, after the rivet punching process, as shown in FIG. 7, the coned-disc spring 94 becomes tilted or uneven with one end 94(a) in contact with the hub member 92 while the other end 94(b) suspended over the brake rotor 93, causing the floating brake disc assembly 9 to malfunction. Therefore, there is then a need for an improved floating brake disc assembly in which the above problem is obviated or at least substantially reduced.

### SUMMARY OF THE INVENTION

Accordingly, it is an object of the present invention to provide a improved floating brake disc assembly in which the coned-disc spring is constructed to be able to well centered on the rivet pin during the punch-riveting process.

To achieve the foregoing objective, the floating brake disc assembly includes generally a disc body and at least one fastener. The disc body includes a hub member and a brake rotor circumferentially around the hub member. The hub member and the brake rotor together define at least one connecting hole through which the fastener is mounted. The fastener includes a rivet pin, a coned-disc spring and a protection washer in close proximity to the coned-disc spring. The coned-disc spring has a conical body having a central hole therein, and at least one positioning post axially extending from the conical body. The protection washer has a central bore and defines in an inner wall of the central bore at least one dent corresponding to the positioning post of the coned-disc spring. The protection washer and the coned-disc spring are engaged to each other with the positioning post of the coned-disc spring being lodged in the dent of the protection washer. The rivet pin passes through the connecting hole of the disc body, the central hole of the coned-disc spring and the central bore of the protection washer so as to fasten the hub member and the brake rotor together while allowing slight floating movement of the brake rotor relative to the hub member therebetween. In such a manner, the engagement between the coned-disc spring and the protection washer ensures that the coned-disc spring is well centered on the rivet pin during the punch-riveting process.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a floating brake disc assembly in accordance with the preferred embodiment of the present invention;

FIG. 2 is an enlarged exploded partial perspective view of the floating brake disc assembly as shown in FIG. 2;

FIG. 3 is a partial cross-sectional view of the floating brake disc assembly shown in FIG. 1, taken along the line;

FIG. 4 is a partial cross-sectional view of the floating brake disc assembly shown in FIG. 1, taken along the line IV-IV;

FIG. 5 is a partial cross-sectional view of a conventional floating brake disc assembly;

FIG. 6 is a partial cross-sectional view of a failed conventional floating brake disc assembly, before the punch-riveting process; and

FIG. 7 is a view similar to FIG. 6, showing the failed floating brake disc assembly after the punch-riveting process.

### DETAILED DESCRIPTION OF EMBODIMENTS

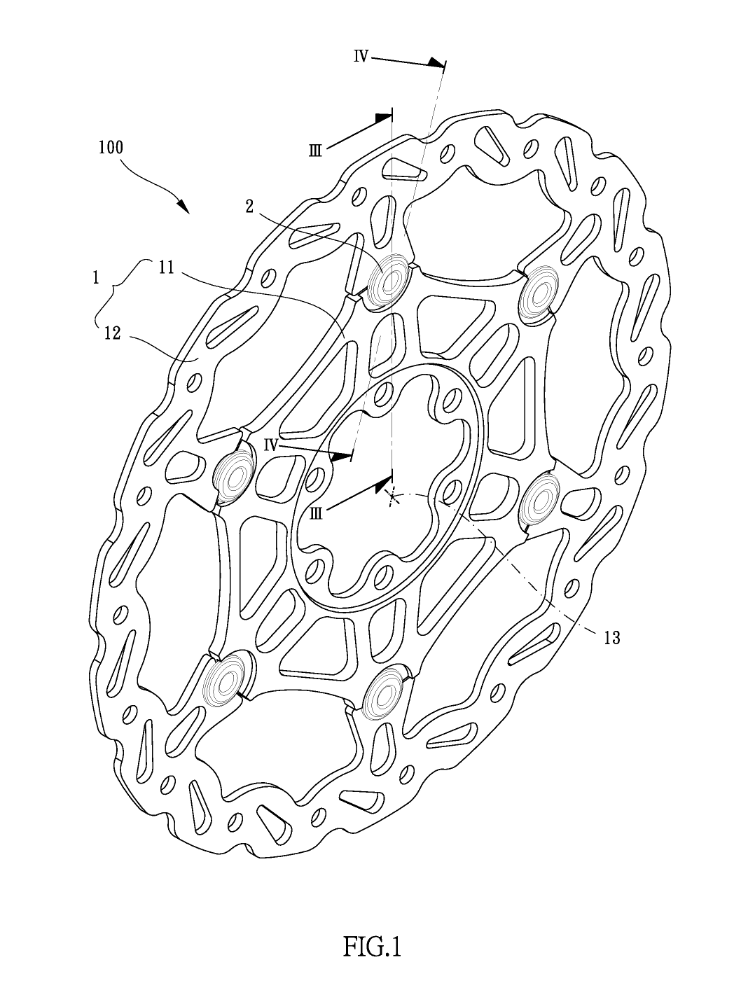

Illustrated in the drawings is a floating brake disc assembly 100 employing the invention. As shown in FIG. 1, the assembly 100 is adapted to be mounted on a wheel (not shown) of a vehicle and generally includes a disc body 1 having a hub member 11 and a brake rotor 12 circumferentially around the hub member 11, and a number of fasteners 2 provided to connect the hub member 11 and the brake rotor 12 together. The hub member 11 has a central hole 13 for reception of a hub axle of the wheel.

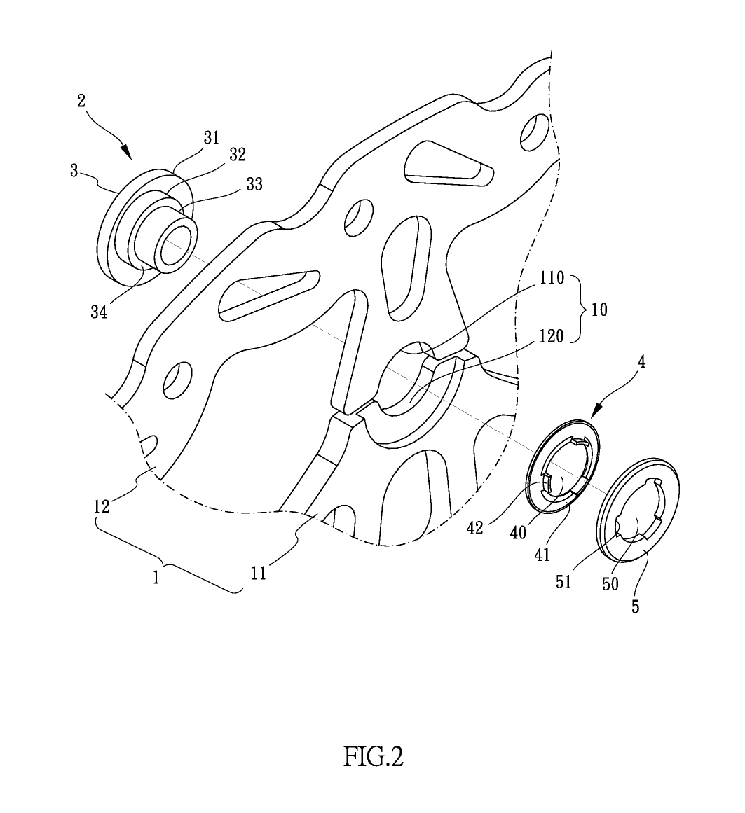

Specifically, as shown in FIG. 2, the hub member 11 defines in its outer periphery a plurality of semicircular recesses 110 spaced apart in a distance. On the other hand, the brake rotor 12 defines in its inner periphery a plurality of opposing semicircular recesses 120. Those semicircular recesses 110, 120 in the hub member 11 and the brake rotor 12 are mated respectively to form a plurality of connecting holes 10 in which the fasteners 2 are mounted.

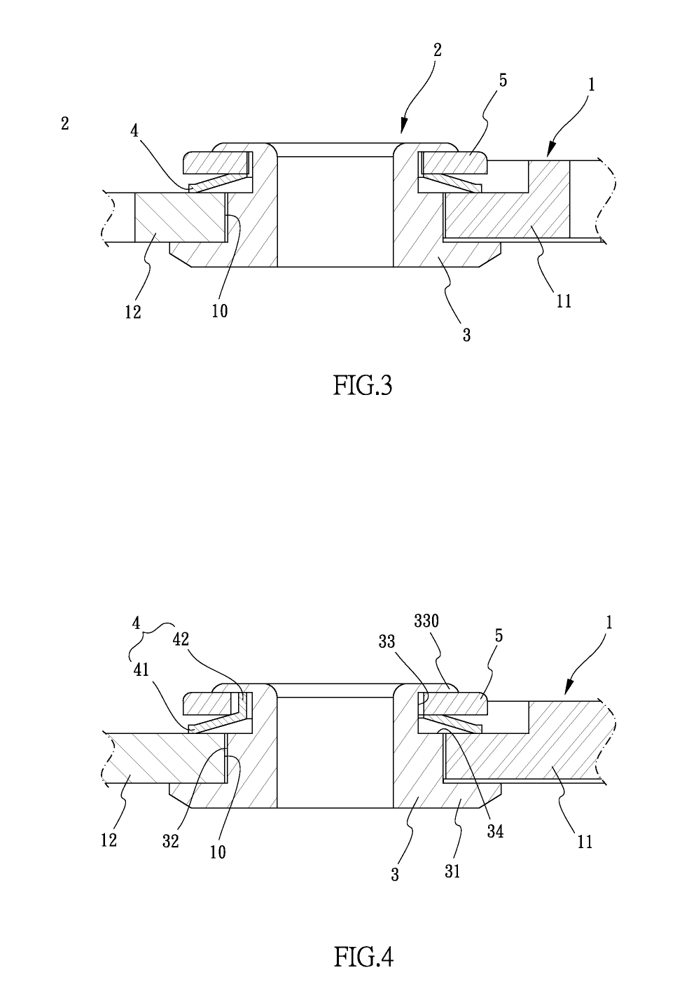

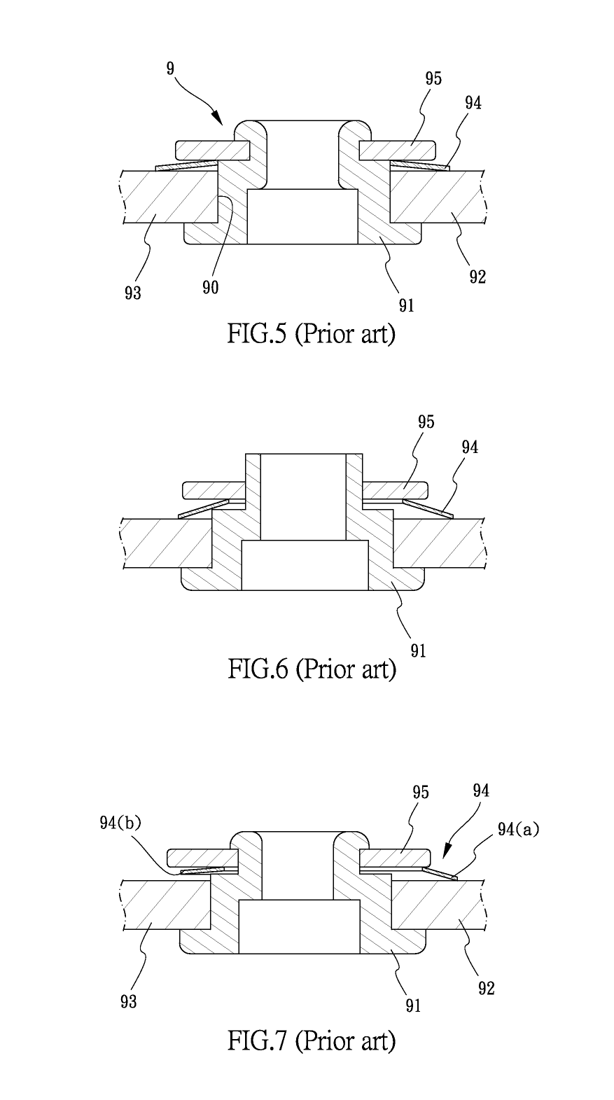

Referring again to FIGS. 2 and 3, each of the fasteners 2 includes a rivet pin 3, a coned-disc spring 4 and a protection washer 5 in close proximity to the coned-disc spring 4. The protection washer 5 has a central bore 50 and defines a plurality of dents 51 in an inner wall of the central bore 50. The coned-disc spring 4 has a conical body 41, a central hole 40 defined in the conical body 41, and a plurality of positioning posts 42 axially extending from the conical body 41 and being lodged in the dents 51 of the protection washer 5, as best seen in FIG. 4. The rivet pin 3 passes into the respective connecting hole 10 of the disc body 1, the central hole 40 of the coned-disc spring 4 and through the central bore 50 of the protection washer 5 so as to fasten the hub member 11 and the brake rotor 12 together while allowing slight floating movement of the brake rotor 12 relative to the hub member 11 therebetween. In this manner, the engagement between the coned-disc spring 4 and the protection washer 5 ensures that the coned-disc spring 4 is well centered on the rivet pin 3 before or after the punch-riveting process.

Referring back to FIG. 2, the rivet pin 3 is hollow and has a head 31, a large-diameter section 32 extending from the head 31, a small-diameter section 33 extending from the large-diameter section 32, and a shoulder 34 formed at the junction between the large-diameter section 32 and the small-diameter section 33. The head 31 of the rivet pin 3 abuts against a side of the disc body 1. The large-diameter section 32 of the rivet pin 3 passes through the connecting hole 10 of the disc body 1 and has a length substantially equal to the depth of the connecting hole of the disc body 1 such that the shoulder 34 of the rivet pin 3 may be flushed with the other side of the disc body 1, as shown in FIG. 3 or 4. The small-diameter section 33 of the rivet pin 3 extends beyond the other side of the disc body 1 and is formed with a radial flared end 330, after the rivet punching process, such that the coned-disc spring 4 together with the protection washer 5 is biased against the other side 10 of the disc body 1 to enable the whole rotor 93 to float in parallel relative to the hub member 92.

In the illustrated embodiment, the coned-disc spring 4 and the protection washer 5 are both mounted around the smaller-diameter section 33 of the rivet pin 3 and sandwiched between the shoulder 34 and the radial flared end 330 of the smaller-diameter 33 of the rivet pin 3. Moreover, the shoulder 34 of the rivet pin 3 is flushed with the other side of the disc body 1 and therefore will not interfere with the movement of the coned-disc spring 4 while in use.

It is also noted that, the coned-disc spring 4 has a concave side 33 and a convex side 44 and is attached to the other side of the disc body 1 with the concave side 33. As such, when a braking force is applied to the brake rotor 12 by means of a brake caliper (not shown), the whole brake rotor 12 can float relative to the hub member 11 in parallel as a result of the coned-disc spring 4 biasing thereto. Similarly, when the brake rotor 12 is released from the caliper, the whole brake rotor 12 can be returned back to its original position due to the elasticity of the coned-disc spring 4.

It is to be understood that the disclosed embodiments are illustrative in nature and the invention is not to be limited to any one or more embodiments except as set forth in the following claims.

What is claimed is:

1. A floating brake disc assembly, comprising:
a disc body including a hub member and a brake rotor circumferentially around the hub member; the hub member and the brake rotor together defining at least one connecting hole; and
at least one fastener including a rivet pin, a coned-disc spring and a protection washer in close proximity to the coned-disc spring; the protection washer having a central bore and defining in an inner wall of the central bore at least one dent; the coned-disc spring having a conical body, a central hole defined in the conical body, and at least one positioning post axially extending from the conical body and being lodged in the dent of the protection washer; wherein the rivet pin passes into the connecting hole of the disc body, the central hole of the coned-disc spring and through the central bore of the protection washer so as to fasten the hub member and the brake rotor together while allowing slight floating movement of the brake rotor relative to the hub member therebetween.

2. The floating brake disc assembly of claim 1, wherein the hub member defines in its outer periphery a semicircular recess; the brake rotor defines in its inner periphery an opposing semicircular recess; and a set of the semicircular recesses in the hub member and the brake rotor serves as said connecting hole defined by the hub member and the brake rotor.

3. The floating brake disc assembly of claim 1, wherein the rivet pin is hollow and has a head, a large-diameter section extending from the head and a small-diameter section extending from the large-diameter section; the head of the rivet pin abuts against a side of the disc body; the large-diameter section of the rivet pin passes through the connecting hole of the disc body; and the small-diameter section extends beyond the other side of the disc body and is formed with a radial flared end such that the coned-disc spring together with the protection washer is biased against the other side of the disc body.

4. The floating brake disc assembly of claim 3, wherein the rivet pin has a shoulder formed at the junction between the large-diameter section and the small-diameter section; and the coned-disc spring and the protection washer are mounted around the smaller-diameter section of the rivet pin and sandwiched between the shoulder and the radial flared end of the smaller-diameter section of the rivet pin.

5. The floating brake disc assembly of claim 4, wherein the shoulder of the rivet pin is flushed with the other side of the disc body.

6. The floating brake disc assembly of claim 3, wherein the coned-disc spring has a convex side and a concave side and is attached to the other side of the disc body with the concave side.
